(19) United States
(12) Patent Application Publication
(10) Pub. No.: US 2025/0211419 A1
(43) Pub. Date: Jun. 26, 2025

(54) INFERENCE METHOD AND APPARATUS FOR LARGE LANGUAGE MODEL, DEVICE, AND STORAGE MEDIUM

(71) Applicant: Beijing Baidu Netcom Science Technology Co., Ltd., Beijing (CN)

(72) Inventors: Zhiyu CHEN, Beijing (CN); Jiwen ZHOU, Beijing (CN); Jingbo ZHOU, Beijing (CN); Zeyu CHEN, Beijing (CN); Chenfu BAO, Beijing (CN); Xia WANG, Beijing (CN); Sheng GUO, Beijing (CN); Huan WANG, Beijing (CN); Yu LI, Beijing (CN); Liguo XU, Beijing (CN); Suochao ZHANG, Beijing (CN)

(21) Appl. No.: 18/749,016

(22) Filed: Jun. 20, 2024

(30) Foreign Application Priority Data
Dec. 26, 2023 (CN) 202311811391.0

(51) Int. Cl. H04L 9/06; G06N 5/04

(52) U.S. Cl. CPC H04L 9/06; G06N 5/04

(57) ABSTRACT

Provided are an inference method and apparatus for a large language model, a device, and a storage medium. The inference method for the large language model includes: performing encryption on a target input text to obtain a target input ciphertext; sending the target input ciphertext to a server so that an encrypted model is used for performing inference on the target input ciphertext by the server to obtain a target result ciphertext; receiving the target result ciphertext sent by the server; and performing decryption on the target result ciphertext to obtain a target result plaintext.

### CROSS-REFERENCE TO RELATED APPLICATION(S)

This application claims priority to Chinese Patent Application No. 202311811391.0 filed Dec. 26, 2023, the disclosure of which is incorporated herein by reference in its entirety.

### TECHNICAL FIELD

The present disclosure relates to the technical field of artificial intelligence and, in particular, to the technical fields of large language models and model encryption, and can be used in a cloud service.

### BACKGROUND

In a process of using a large language model on a cloud, the large language model is finely tuned and performs the inference by using an interface on the cloud. In these two processes, a user must upload data used in these processes to a cloud service in a form of a plaintext, and a result is also returned to a client through the cloud service. This plaintext interaction manner causes the problem that when the user uses the large language model on the cloud, private information of the user is leaked. A specific privacy risk includes a risk of transmission on the cloud, a risk of stealing by an operator, a risk of snooping between tenants and finally, a risk of privacy leakage caused by a memory ability of the large language model.

At present, two main solutions are provided. One is based on a solution of homomorphic cryptography. However, the solution is performed at a slow speed and can only be applied to a small model. Moreover, only inference can be completed, and a fine-tuning operation is not supported. The other is a solution based on differential privacy. Noises are added at different levels of the model to protect data communication from the client to a server. However, the solution is performed with a relatively high precision loss. Based on the differential manner, only unidirectional data, that is, data from the client to the server can be protected, but data from the server to the client cannot be protected.

### SUMMARY

The present disclosure provides an inference method and apparatus for a large language model, a device and a storage medium.

According to an aspect of the present disclosure, an inference method for a large language model is provided. The inference method for the large language model is applied to a client and includes the following.

Encryption is performed on a target input text to obtain a target input ciphertext.

The target input ciphertext is sent to a server so that an encrypted model is used for performing inference on the target input ciphertext by the server to obtain a target result ciphertext. The target result ciphertext sent by the server is received.

Decryption is performed on the target result ciphertext to obtain a target result plaintext. According to another aspect of the present disclosure, an inference method for a large

language model is provided. The inference method for the large language model is applied to a server and includes the following.

A target input ciphertext sent by a client is received.

Inference is performed on the target input ciphertext by using an encrypted model to obtain a target result ciphertext.

The target result ciphertext is sent to the client so that the client performs decryption on the target result ciphertext to obtain a target result plaintext.

According to another aspect of the present disclosure, an inference apparatus for a large language model is provided. The inference apparatus for the large language model is configured in a client and includes a target input ciphertext determination module, a target input ciphertext sending module, a target result ciphertext receiving module and a target result plaintext determination module.

The target input ciphertext determination module is configured to perform encryption on a target input text to obtain a target input ciphertext.

The target input ciphertext sending module is configured to send the target input ciphertext to a server so that an encrypted model is used for performing inference on the target input ciphertext by the server to obtain a target result ciphertext.

The target result ciphertext receiving module is configured to receive the target result ciphertext sent by the server.

The target result plaintext determination module is configured to perform decryption on the target result ciphertext to obtain a target result plaintext.

According to another aspect of the present disclosure, an inference apparatus for a large language model is provided. The inference apparatus for the large language model is configured in a server and includes a target input ciphertext receiving module, a target result ciphertext determination module and a target result ciphertext sending module.

The target input ciphertext receiving module is configured to receive a target input ciphertext sent by a client.

The target result ciphertext determination module is configured to perform inference on the target input ciphertext by using an encrypted model to obtain a target result ciphertext.

The target result ciphertext sending module is configured to send the target result ciphertext to the client so that the client performs decryption on the target result ciphertext to obtain a target result plaintext.

According to another aspect of the present disclosure, an electronic device is provided. The electronic device includes at least one processor and a memory communicatively connected to the at least one processor.

The memory stores instructions executable by the at least one processor to cause the at least one processor to perform the inference method for the large language model according to any embodiment of the present disclosure.

According to another aspect of the present disclosure, a non-transitory computer-readable storage medium is provided. The storage medium stores computer instructions for causing a computer to perform the inference method for the large language model according to any embodiment of the present disclosure.

According to another aspect of the present disclosure, a computer program product is provided. The computer program product includes a computer program which, when executed by a processor, causes the processor to implement the inference method for the large language model according to any embodiment of the present disclosure.

According to the technique of the present disclosure, data security in a model reasoning process can be improved.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solutions and not to limit the present disclosure.

FIG. 1 is a flowchart of an inference method for a large language model according to an embodiment of the present disclosure.

FIG. 2 is a flowchart of another inference method for a large language model according to an embodiment of the present disclosure.

FIG. 3 is a flowchart of another] inference method for a large language model according to an embodiment of the present disclosure.

FIG. 4 is a flowchart of another inference method for a large language model according to an embodiment of the present disclosure.

FIG. 5 is a flowchart of an inference method for a large language model according to an embodiment of the present disclosure.

FIG. 6 is a flowchart of another inference method for a large language model according to an embodiment of the present disclosure.

FIG. 7 is a structural diagram of an inference apparatus for a large language model according to an embodiment of the present disclosure.

FIG. 8 is a structural diagram of an inference apparatus for a large language model according to an embodiment of the present disclosure.

FIG. 9 is a block diagram of an electronic device for implementing an inference method for a large language model according to an embodiment of the present disclosure.

### DETAILED DESCRIPTION

Example embodiments of the present disclosure, including details of embodiments of the present disclosure, are described hereinafter in conjunction with drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

It is to be noted that the terms “first”, “second”, “target”, “transverse”, “longitudinal” and “intermediate” in the description, claims and drawings of the present disclosure are used to distinguish between similar objects and are not necessarily used to describe a particular order or sequence. It should be understood that the data used in this way is interchangeable where appropriate so that the embodiment of the present disclosure described herein may also be implemented in a sequence not illustrated or described herein. In addition, the terms “include”, “have” or any other variations thereof are intended to encompass a non-exclusive inclusion. For example, a process, method, system, product or equipment that includes a series of steps or units not only includes the expressly listed steps or units but may also include other steps or units that are not expressly listed or are inherent to such process, method, product or equipment.

In addition, it is to be further noted that processing such as collection, storage, use, processing, transmission, provision and disclosure of related data such as a target input ciphertext, a to-be-jitter training text, a fine-tuning input text and a large language pre-training model that are involved in the technical solution of the present disclosure complies with provisions of relevant laws and regulations and does not violate public order and good customs.

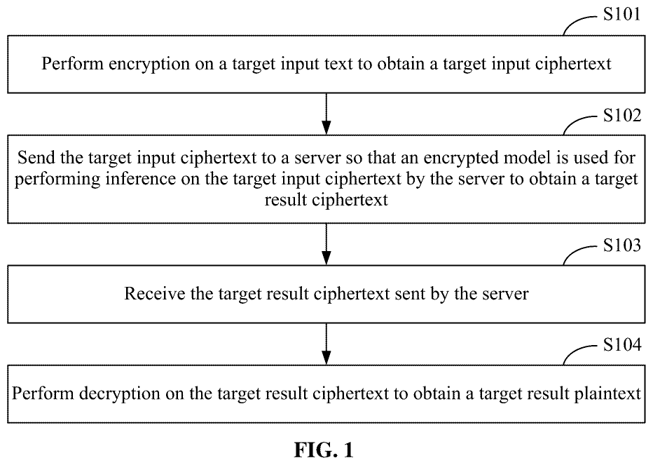

FIG. 1 is a flowchart of an inference method for a large language model according to an embodiment of the present disclosure. This embodiment is applied to the case of how to improve data security in a cloud service, for example, an application scenario like smart question-answering or text retrieval. The method may be performed by an inference apparatus for a large language model. The apparatus may be implemented by software and/or hardware and may be integrated into an electronic device carrying an large language model inference function, for example, a client. As shown in FIG. 1, the inference method for the large language model of this embodiment may include the steps described below.

In S101, encryption is performed on a target input text to obtain a target input ciphertext.

In this embodiment, the target input text refers to an input text for privacy inference, for example, may be a question text input by a client in a privacy intelligent question-answering application or a content text questioned in a privacy document retrieval system. The so-called target input ciphertext refers to data obtained after the encryption processing is performed on the target input text. Optionally, the target input ciphertext may be represented in a form of a vector or a matrix, for example, may be a string of digits.

In an optional manner, the encryption can be performed on the target input text based on a preset encryption manner to obtain the target input ciphertext. For example, the encryption can be performed on the target input text in a symmetric encryption manner to obtain the target input ciphertext.

In S102, the target input ciphertext is sent to a server so that an encrypted model is used for performing inference on the target input ciphertext by the server to obtain a target result ciphertext.

In this embodiment, the target result ciphertext refers to a result ciphertext obtained after the model performs inference on the target input ciphertext, that is, a ciphertext of a question-answering result or a search result. Optionally, the target result ciphertext may be represented in a form of a vector or a matrix, for example, may be a string of digits. The so-called encrypted model refers to a model obtained after training a large language pre-training model by using encrypted input related data. The large language model may be Bloom model, Llama model or Ernie model.

Specifically, the client sends the target input ciphertext to the server. Correspondingly, the server receives the target input ciphertext sent by the client, a local encrypted model is used for performing inference on the target input ciphertext to obtain the target result ciphertext, and the target result ciphertext is fed back to the client.

In S103, the target result ciphertext sent by the server is received.

Specifically, the client can receive the target result ciphertext sent by the server.

In S104, decryption is performed on the target result ciphertext to obtain a target result plaintext.

In this embodiment, the target result plaintext refers to a plaintext obtained after the decryption is performed on the target result ciphertext, that is, an answer text corresponding to the target input text.

In an optional manner, the decryption can be performed on the target result ciphertext based on a decryption manner corresponding to the preset encryption manner to obtain the target result plaintext.

In the technical solution provided in the embodiment of the present disclosure, the encryption is performed on the target input text to obtain the target input ciphertext; the target input ciphertext is sent to the server so that the encrypted model is used for performing inference on the target input ciphertext by the server to obtain the target result ciphertext; the target result ciphertext sent by the server is received; the decryption is performed on the target result ciphertext to obtain the target result plaintext. In the above technical solution, inference is performed on the ciphertext input from the client based on the encrypted model to obtain the result ciphertext, and the result ciphertext is transmitted to the client so that the decryption is performed based on the result ciphertext by the client to obtain the result plaintext, thereby bidirectionally protecting data, that is, protecting both data from the client to the server and data from the server to the client.

On the basis of the preceding embodiment, as an optional manner of the present disclosure, performing the encryption on the target input text to obtain the target input ciphertext includes: encoding the target input text based on a vocabulary of a large language pre-training model to obtain target input encoding; and performing transverse jitter encryption on the target input encoding by using a transverse jitter key to obtain the target input ciphertext.

The target input encoding refers to data obtained after the target input text is encoded and may be represented in a form of a vector or a matrix, for example, may be a string of digits. The so-called transverse jitter key refers to a key for adjusting left and right positions of to-be-encrypted data (for example, a to-be-encrypted vector element). The so-called transverse jitter encryption is an encryption processing process of shuffling left and right positions of the vector element based on the transverse jitter key.

Specifically, word embedding processing can be performed on the target input text based on the vocabulary of the large language pre-training model to obtain the target input encoding, and the transverse jitter encryption is performed on the target input encoding by using the transverse jitter key to obtain the target input ciphertext.

It may be understood that the target input text is first encoded based on the vocabulary to become an encoded vector and then encryption is performed on the input encoded vector by using the transverse jitter key, thereby ensuring the data privacy and security of the input text data.

On the basis of the preceding embodiment, as an optional manner of the present disclosure, performing the decryption on the target result ciphertext to obtain the target result plaintext includes: performing the decryption on the target result ciphertext by using a transverse jitter key to obtain a target decryption result; and performing text decoding on the target decryption result to obtain the target result plaintext.

The target decryption result refers to data obtained after key decryption is performed on the target result ciphertext and may be represented in a form of a vector or a matrix, for example, may be a string of digits.

Specifically, the decryption can be performed on the target result ciphertext by using the transverse jitter key to obtain the target decryption result, and the text decoding can be performed on the target decryption result based on a vocabulary to obtain the target result plaintext.

It may be understood that after receiving the ciphertext data, the client performs local plaintext conversion, thereby fully ensuring data privacy.

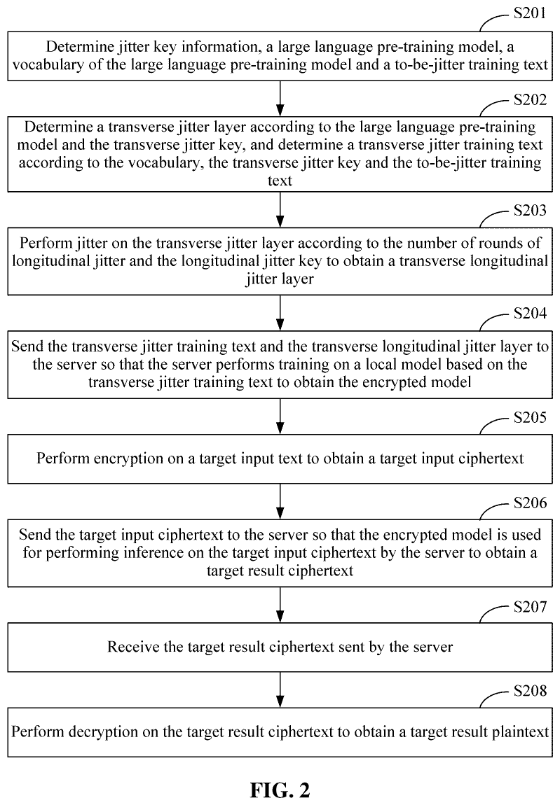

FIG. 2 is a flowchart of another inference method for a large language model according to an embodiment of the present disclosure. On the basis of the preceding embodiment, in this embodiment, a process of determining the encrypted model is specifically elaborated, and an optional implementation solution is provided. As shown in FIG. 2, the inference method for the large language model of this embodiment may include the steps described below.

In S201, jitter key information, a large language pre-training model, a vocabulary of the large language pre-training model and a to-be-jitter training text are determined.

In this embodiment, the jitter key information refers to key-related information for performing encryption on the training text and the large language model. Optionally, the jitter key information includes a transverse jitter key, the number of rounds of longitudinal jitter and a longitudinal jitter key. The longitudinal jitter key refers to a key for encrypting by adjusting and up and down positions of to-be-encrypted data (for example, a to-be-encrypted vector element). The number of rounds of longitudinal jitter refers to the number of rounds of performing longitudinal jitter encryption and may be set by those skilled in the art according to an actual situation. The so-called vocabulary of the large language pre-training model refers to a vocabulary for vectorizing data of an input model. The so-called to-be-jitter training text refers to a training text applied to jitter encryption, for example, may be a question-answering text training set.

Specifically, the client can acquire the large language pre-training model and the vocabulary of the large language pre-training model from the server and locally acquire the jitter key information and the to-be-jitter training text.

In S202, a transverse jitter layer is determined according to the large language pre-training model and the transverse jitter key, and a transverse jitter training text is determined according to the vocabulary, the transverse jitter key and the to-be-jitter training text.

In this embodiment, the transverse jitter layer refers to a presentation layer or an embedded layer obtained after transverse encryption is performed on a parameter weight of a presentation layer or an embedded layer in the large language pre-training model. The so-called transverse jitter training text refers to a training text obtained after transverse encryption is performed on the to-be-jitter training text.

In an optional manner, the transverse encryption can be performed on the parameter weight of the presentation layer or the embedded layer in the large language pre-training model by using the transverse jitter key to obtain the transverse jitter layer.

In another optional manner, the to-be-jitter training text can be processed based on the vocabulary to obtain a vectorized text, and transverse encryption can be performed on the vectorized text by using the transverse jitter key to obtain the transverse jitter training text.

In S203, jitter is performed on the transverse jitter layer according to the number of rounds of longitudinal jitter and the longitudinal jitter key to obtain a transverse longitudinal jitter layer.

In this embodiment, the transverse longitudinal jitter layer refers to a presentation layer or an embedded layer obtained after longitudinal jitter encryption is performed on the transverse jitter layer. The so-called longitudinal jitter encryption is an encryption processing process of shuffling left and right positions of a model parameter weight based on the longitudinal jitter key.

In an optional manner, multiple rounds of jitter encryption are performed on the transverse jitter layer by using the longitudinal jitter key, and until jitter meets the number of rounds of longitudinal jitter, the jitter is stopped to obtain the transverse longitudinal jitter layer.

In S204, the transverse jitter training text and the transverse longitudinal jitter layer are sent to the server so that the server performs training on a local model based on the transverse jitter training text to obtain the encrypted model.

Specifically, the client can send the transverse jitter training text and a transverse longitudinal jitter layer obtained after each round of jitter to the server. Accordingly, the server acquires the transverse jitter training text and the transverse longtiudinal jitter layer that are sent by the client, the transverse longitudinal jitter layer obtanined after the each round of hitters is used for updating the local model, and interative training is performed on the updated local model by using the transverse jitter training text to obtain the excrypted model.

In S205, encryption is performed on a target input text to obtain a target input ciphertext.

In S206, the target input ciphertext is sent to the server so that the encrypted model is used for performing inference on the target input ciphertext by the server to obtain a target result ciphertext.

In S207, the target result ciphertext sent by the server is received.

In S208, decryption is performed on the target result ciphertext to obtain a target result plaintext.

In the technical solution provided in the embodiment of the present disclosure, the jitter key information, the large language pre-training model, the vocabulary of the large language pre-training model and the to-be-jitter training text are determined, where the jitter key information includes the transverse jitter key, the number of rounds of longitudinal jitter and the longitudinal jitter key; the transverse jitter layer is determined according to the large language pre-training model and the transverse jitter key, and the transverse jitter training text is determined according to the vocabulary, the transverse jitter key and the to-be-jitter training text; the jitter is performed on the transverse jitter layer according to the number of rounds of longitudinal jitter and the longitudinal jitter key to obtain the transverse longitudinal jitter layer; the transverse jitter training text and the transverse longitudinal jitter layer are sent to the server so that the server performs the training on the local model based on the transverse jitter training text to obtain the encrypted model; the encryption is performed on the target input text to obtain the target input ciphertext; the target input ciphertext is sent to the server so that the encrypted model is used for performing inference on the target input ciphertext by the server to obtain the target result ciphertext; the target result ciphertext sent by the server is received; the decryption is performed on the target result ciphertext to obtain the target result plaintext. In the above technical solution, transverse longitudinal dual encryption is performed on the large language pre-training model by using the transverse jitter key and the longitudinal jitter key to obtain the encrypted model, thereby ensuring the dual security of the data obtained by inference based on the encrypted model.

On the basis of the preceding embodiment, as an optional manner of the present disclosure, determining the transverse jitter layer according to the large language pre-training model and the transverse jitter key includes: acquiring a parameter weight of an embedded layer or a presentation layer in the large language pre-training model; and performing transverse jitter on the embedded layer or the presentation layer according to the parameter weight of the embedded layer or the presentation layer and the transverse jitter key to obtain the transverse jitter layer.

Specifically, the client can acquire the parameter weight of the embedded layer or the presentation layer from an obtained parameter weight of the large language pre-training model and perform the transverse jitter on the parameter weight of the embedded layer or the presentation layer by using the transverse jitter key to obtain the transverse jitter layer.

It may be understood that performing the transverse jitter on the embedded layer or the presentation layer only changes a transverse position of the parameter weight in the embedded layer or the presentation layer. However, original information of the parameter of the model is invisibly retained so that the client can locally record the original information of the model.

On the basis of the preceding embodiment, as an optional manner of the present disclosure, determining the transverse jitter training text according to the vocabulary, the transverse jitter key and the to-be-jitter training text includes: encoding the to-be-jitter training text based on the vocabulary to obtain training text encoding; and performing transverse jitter processing on the training text encoding by using the transverse jitter key to obtain the transverse jitter training text.

The training text encoding refers to data obtained after the to-be-jitter training text is encoded and may be represented in a form of a vector or a matrix.

Specifically, word embedding processing can be performed on the to-be-jitter training text based on the vocabulary to obtain the training text encoding, and the transverse jitter processing, that is, the transverse encryption processing, is performed on the training text encoding by using the transverse jitter key to obtain the transverse jitter training text.

It may be understood that the encryption processing is performed on the to-be-jitter training text by using the transverse jitter key, thereby ensuring the privacy and security of the training data of the model.

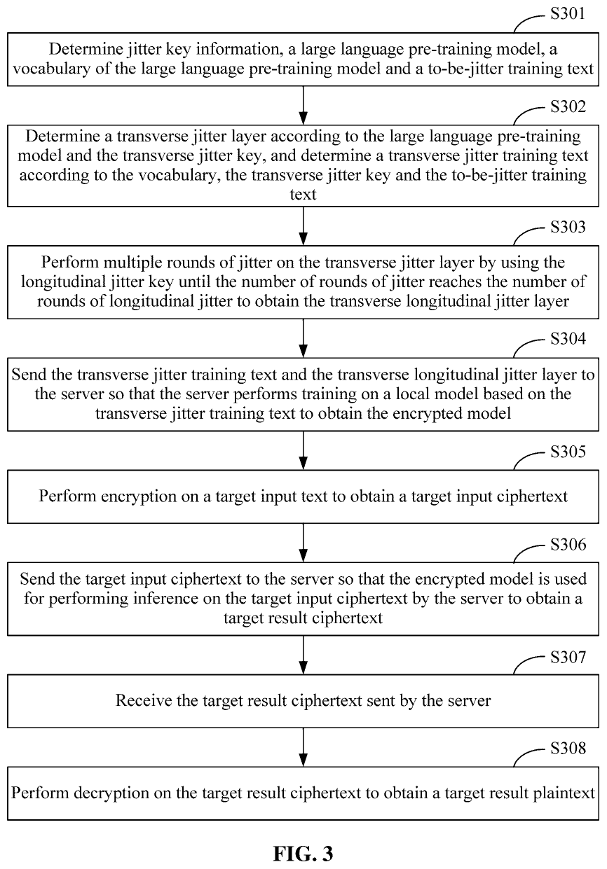

FIG. 3 is a flowchart of another inference method for large language model according to an embodiment of the present disclosure. On the basis of the preceding embodiment, in this embodiment, the step that “jitter is performed on the transverse jitter layer according to the number of rounds of longitudinal jitter and the longitudinal jitter key to obtain a transverse longitudinal jitter layer” is further optimized, and an optional implementation solution is provided. As shown in FIG. 3, the inference method for large language model of this embodiment may include the steps described below.

In S301, jitter key information, a large language pre-training model, a vocabulary of the large language pre-training model and a to-be-jitter training text are determined.

The jitter key information includes a transverse jitter key, the number of rounds of longitudinal jitter and a longitudinal jitter key.

In S302, a transverse jitter layer is determined according to the large language pre-training model and the transverse jitter key, and a transverse jitter training text is determined according to the vocabulary, the transverse jitter key and the to-be-jitter training text.

In S303, multiple rounds of jitter are performed on the transverse jitter layer by using the longitudinal jitter key until the number of rounds of jitter reaches the number of rounds of longitudinal jitter to obtain the transverse longitudinal jitter layer.

Specifically, a longitudinal jitter key corresponding to an i-th round of jitter is determined for the i-th round of jitter, and longitudinal jitter is performed on an intermediate jitter layer corresponding to an (i-1)-th round of jitter by using the longitudinal jitter key to obtain a transverse longitudinal jitter layer corresponding to the i-th round of jitter, where i is a natural number greater than 0 and is less than or equal to the number of rounds of longitudinal jitter; when i is 1, the intermediate jitter layer is the transverse jitter layer, and when i is greater than 1, the intermediate jitter layer is a transverse longitudinal jitter layer corresponding to the (i-1)-th round of jitter. That is, when a first round of jitter is performed, longitudinal jitter, that is, encryption, is performed on the transverse jitter layer by using a longitudinal jitter key corresponding to the first round of jitter to obtain a transverse longitudinal jitter layer corresponding to the first round of jitter, and when a subsequent round of jitter except the first round of jitter is performed, longitudinal jitter, that is, encryption, is performed on a transverse longitudinal jitter layer obtained in a previous round of the round by using a longitudinal jitter key corresponding to the round of jitter to obtain a transverse longitudinal jitter layer corresponding to the round of jitter. Until the number of rounds of jitter reaches the number of rounds of longitudinal jitter, the longitudinal jitter is stopped.

It is to be noted that different longitudinal jitter keys are used in different rounds of jitter and the longitudinal jitter key can be generated based on a key generator. Optionally, the longitudinal jitter key may include a longitudinal jitter operator and an operator parameter.

In S304, the transverse jitter training text and the transverse longitudinal jitter layer are sent to the server so that the server performs training on a local model based on the transverse jitter training text to obtain the encrypted model.

In S305, encryption is performed on a target input text to obtain a target input ciphertext.

In S306, the target input ciphertext is sent to the server so that the encrypted model is used for performing inference on the target input ciphertext by the server to obtain a target result ciphertext.

In S307, the target result ciphertext sent by the server is received.

In S308, decryption is performed on the target result ciphertext to obtain a target result plaintext.

In the technical solution provided in the embodiment of the present disclosure, the jitter key information, the large language pre-training model, the vocabulary of the large language pre-training model and the to-be-jitter training text are determined, where the jitter key information includes the transverse jitter key, the number of rounds of longitudinal jitter and the longitudinal jitter key; the transverse jitter layer is determined according to the large language pre-training model and the transverse jitter key, and the transverse jitter training text is determined according to the vocabulary, the transverse jitter key and the to-be-jitter training text; the multiple rounds of jitter are performed on the transverse jitter layer by using the longitudinal jitter key until the number of rounds of jitter reaches the number of rounds of longitudinal jitter to obtain the transverse longitudinal jitter layer; the transverse jitter training text and the transverse longitudinal jitter layer are sent to the server so that the server performs the training on the local model based on the transverse jitter training text to obtain the encrypted model; the encryption is performed on the target input text to obtain the target input ciphertext; the target input ciphertext is sent to the server so that the encrypted model is used for performing inference on the target input ciphertext by the server to obtain the target result ciphertext; the target result ciphertext sent by the server is received; the decryption is performed on the target result ciphertext to obtain the target result plaintext. In the above technical solution, transverse jitter is performed once on the model, and the multiple rounds of longitudinal jitter are performed by using different longitudinal jitter keys so that the obtained encrypted model can be more secure.

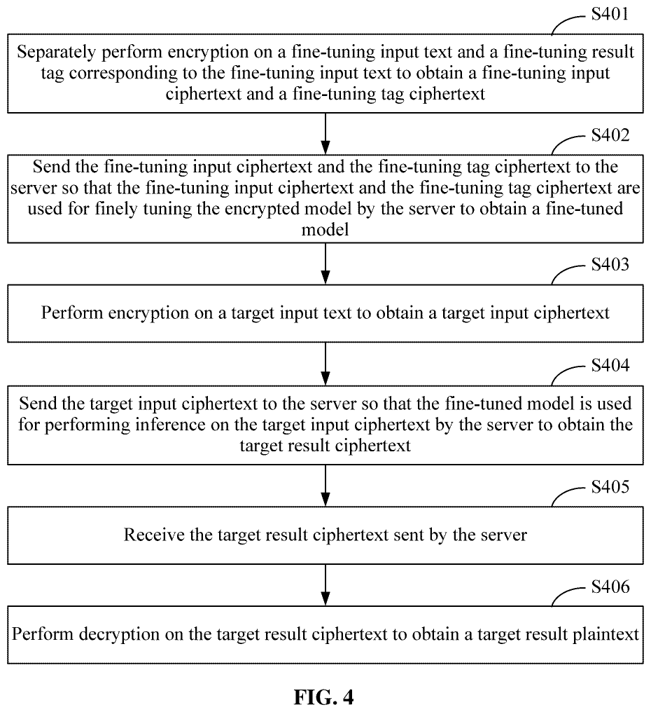

FIG. 4 is a flowchart of another inference method for large language model according to an embodiment of the present disclosure. On the basis of the preceding embodiment, in this embodiment, the encrypted model is further finely tuned, a process of finely tuning a fine-tuned model is elaborated in detail, and an optional implementation solution is provided. As shown in FIG. 4, the inference method for large language model of this embodiment may include the steps described below.

In S401, encryption is separately performed on a fine-tuning input text and a fine-tuning result tag corresponding to the fine-tuning input text to obtain a fine-tuning input ciphertext and a fine-tuning tag ciphertext.

In this embodiment, the fine-tuning input text refers to a training text for finely tuning the encrypted model. The so-called fine-tuning result tag refers to tag data of the fine tuning input text, that is, a real result text corresponding to the fine-tuning input text. The so-called fine-tuning input ciphertext refers to data obtained after the encryption processing is performed on the fine-tuning input text. Optionally, the fine-tuning input ciphertext may be represented in a form of a vector or a matrix, for example, may be a string of digits. The so-called fine-tuning tag ciphertext refers to data obtained after the encryption processing is performed on the fine-tuning result tag. Optionally, the fine-tuning tag ciphertext may be represented in a form of a vector or a matrix, for example, may be a string of digits.

In an optional manner, the encryption can be separately performed on the fine-tuning input text and the fine-tuning result tag based on a preset encryption manner to obtain the fine-tuning input ciphertext and the fine-tuning tag ciphertext. For example, the encryption can be separately performed on the fine-tuning input text and the fine-tuning result tag in a symmetric encryption manner to obtain the fine-tuning input ciphertext and the fine-tuning tag ciphertext.

In S402, the fine-tuning input ciphertext and the fine-tuning tag ciphertext are sent to the server so that the fine-tuning input ciphertext and the fine-tuning tag ciphertext are used for finely tuning the encrypted model by the server to obtain a fine-tuned model.

In this embodiment, the fine-tuned model refers to a model obtained after the encrypted model is finely tuned.

Specifically, the client sends the fine-tuning input ciphertext and the fine-tuning tag ciphertext to the server. Accordingly, the fine-tuning input ciphertext and the fine-tuning tag ciphertext are used for finely tuning the encrypted model by the server to obtain the fine-tuned model.

In S403, encryption is performed on a target input text to obtain a target input ciphertext.

In S404, the target input ciphertext is sent to the server so that the fine-tuned model is used for performing inference on the target input ciphertext by the server to obtain the target result ciphertext.

Specifically, the client sends the target input ciphertext to the server. Accordingly, the server receives the target input ciphertext sent by the client, a local fine-tuned model is used for performing inference on the target input ciphertext to obtain the target result ciphertext, and the target result ciphertext is fed back to the client.

In S405, the target result ciphertext sent by the server is received.

In S406, decryption is performed on the target result ciphertext to obtain a target result plaintext.

In the technical solution provided in the embodiment of the present disclosure, the encryption is separately performed on the fine-tuning input text and the fine-tuning result tag corresponding to the fine-tuning input text to obtain the fine-tuning input ciphertext and the fine-tuning tag ciphertext; the fine-tuning input ciphertext and the fine-tuning tag ciphertext are sent to the server so that the fine-tuning input ciphertext and the fine-tuning tag ciphertext are used for finely tuning the encrypted model by the server to obtain the fine-tuned model; the encryption is performed on the target input text to obtain the target input ciphertext; the target input ciphertext is sent to the server so that the fine-tuned model is used for performing inference on the target input ciphertext by the server to obtain the target result ciphertext; the target result ciphertext sent by the server is received; the decryption is performed on the target result ciphertext to obtain the target result plaintext. In the above technical solution, the input ciphertext data is used for further finely tuning the encrypted model, thereby training a more personalized exclusive encrypted model.

On the basis of the preceding embodiment, as an optional manner of the present disclosure, separately performing the encryption on the fine-tuning input text and the fine-tuning result tag corresponding to the fine-tuning input text to obtain the fine-tuning input ciphertext and the fine-tuning tag ciphertext includes: separately encoding the fine-tuning input text and the fine-tuning result tag corresponding to the fine-tuning input text based on the vocabulary to obtain fine-tuning input encoding and fine-tuning tag encoding; and separately performing encryption on the fine-tuning input encoding and the fine-tuning tag encoding by using the transverse jitter key to obtain the fine-tuning input ciphertext and the fine-tuning tag ciphertext.

The fine-tuning input encoding refers to data obtained after the fine-tuning input text is encoded. Optionally, the fine-tuning input encoding may be represented in a form of a vector or a matrix, for example, may be a string of digits. The so-called fine-tuning tag encoding refers to data obtained after the fine-tuning result tag is encoded. Optionally, the fine-tuning tag encoding may be represented in a form of a vector or a matrix, for example, may be a string of digits.

Specifically, word embedding processing is separately performed on the fine-tuning input text and the fine-tuning result tag corresponding to the fine-tuning input text based on the vocabulary of the large language pre-training model to obtain the fine-tuning input encoding and the fine-tuning tag encoding, and the encryption is separately performed on the fine-tuning input encoding and the fine-tuning tag encoding by using the transverse jitter key to obtain the fine-tuning input ciphertext and the fine-tuning tag ciphertext.

It may be understood that the fine-tuning input text and the fine-tuning result tag are first encoded based on the vocabulary to become encoded vectors and then encryption is performed on the obtained encoded vectors by using the transverse jitter key, thereby finely tuning the model in the case of the ciphertexts.

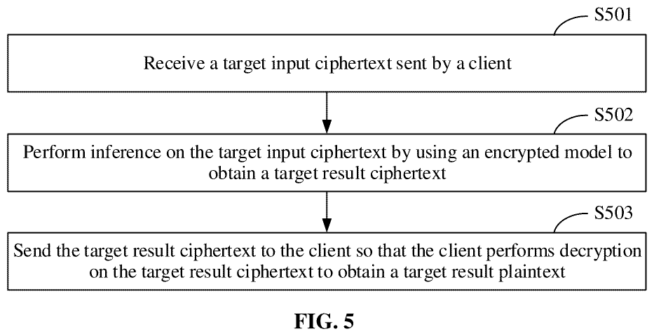

FIG. 5 is a flowchart of an inference method for large language model according to an embodiment of the present disclosure. This embodiment is applied to the case of how to improve data security in a cloud service, for example, an application scenario like smart question-answering or text retrieval. The method may be performed by an inference apparatus for large language model. The apparatus may be implemented by software and/or hardware and may be integrated into an electronic device carrying an large language model inference function, for example, a server. As shown in FIG. 5, the inference method for large language model of this embodiment may include the steps described below.

In S501, a target input ciphertext sent by a client is received.

Specifically, the server receives the target input ciphertext sent by the client.

In S502, inference is performed on the target input ciphertext by using an encrypted model to obtain a target result ciphertext.

Specifically, the encrypted model is used for performing privacy inference on the target input ciphertext based on an inference-related parameter by the server to obtain the target result ciphertext.

In S503, the target result ciphertext is sent to the client so that the client performs decryption on the target result ciphertext to obtain a target result plaintext.

Specifically, the server sends the target result ciphertext to the client. Accordingly, the client receives the target result ciphertext and performs the decryption processing on the target result ciphertext to obtain the target result plaintext. For example, the decryption can be performed on the target result ciphertext by using a transverse jitter key to obtain a target decryption result, and text decoding is performed on the target decryption result to obtain the target result plaintext.

In the technical solution provided in the embodiment of the present disclosure, the target input ciphertext sent by the client is received; inference is performed on the target input ciphertext by using the encrypted model to obtain the target result ciphertext; the target result ciphertext is sent to the client so that the client performs the decryption on the target result ciphertext to obtain the target result plaintext. In the above technical solution, inference is performed on the ciphertext input from the client based on the encrypted model to obtain the result ciphertext, and the result ciphertext is transmitted to the client so that the decryption is performed based on the result ciphertext by the client to obtain the result plaintext, thereby bidirectionally protecting data, that is, protecting both data from the client to the server and data from the server to the client.

On the basis of the preceding embodiment, as an optional manner of the present disclosure, a process of determining the encrypted model includes: acquiring a transverse jitter training text and a transverse longitudinal jitter layer that are sent by the client; and performing training on a local model based on the transverse jitter training text to obtain the encrypted model.

Specifically, the server acquires the transverse jitter training text and the transverse longitudinal jitter layer that are sent by the client, the transverse longitudinal jitter layer is used for updating the local model, and iterative training is performed on the updated local model by using the transverse jitter training text to obtain the encrypted model.

It may be understood that the iterative training is performed on the transverse longitudinal jitter layer, that is, a model obtained after encryption is performed on a related parameter by using the encrypted training data sent by the client so that the model of the server has privacy, thereby avoiding the privacy leakage of the model caused by an interaction process between the client and the server.

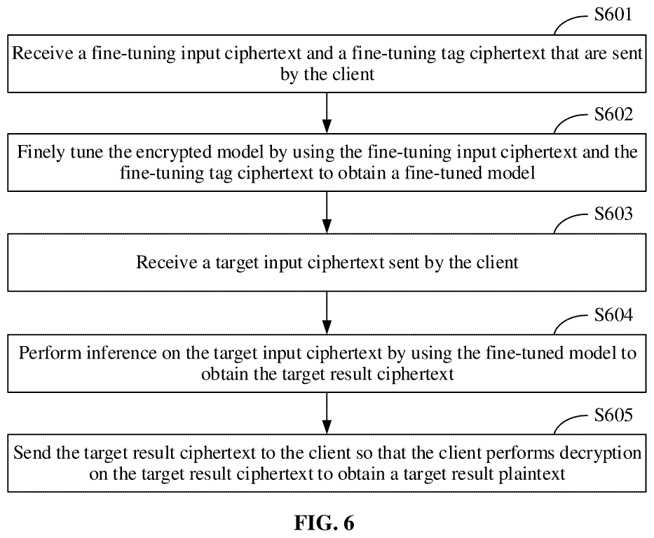

FIG. 6 is a flowchart of another inference method for large language model according to an embodiment of the present disclosure. On the basis of the preceding embodiment, in this embodiment, the encrypted model is further finely tuned, a process of finely tuning a fine-tuned model is elaborated in detail, and an optional implementation solution is provided. As shown in FIG. 6, the inference method for large language model of this embodiment may include the steps described below.

In S601, a fine-tuning input ciphertext and a fine-tuning tag ciphertext that are sent by the client are received.

Specifically, the server can receive the fine-tuning input ciphertext and the fine-tuning tag ciphertext that are sent by the client.

In S602, the encrypted model is finely tuned by using the fine-tuning input ciphertext and the fine-tuning tag ciphertext to obtain a fine-tuned model.

In an optional manner, the fine-tuning input ciphertext is predicted by using the encrypted model to obtain a prediction result ciphertext, a training loss is determined according to the prediction result ciphertext and the fine-tuning tag ciphertext, and reverse weight update is performed on the encrypted model by using the training loss to obtain the fine-tuned model. The prediction result ciphertext refers to a result ciphertext obtained after inference is performed by using the encrypted model.

Specifically, forward inference is performed on the fine-tuning input ciphertext by the encrypted model to obtain the prediction result ciphertext, the training loss is determined according to the prediction result ciphertext and the fine-tuning tag ciphertext, a model gradient is calculated based on the training loss, and the reverse weight update is performed on the encrypted model according to the model gradient to obtain the fine-tuned model.

In S603, a target input ciphertext sent by the client is received.

In S604, inference is performed on the target input ciphertext by using the fine-tuned model to obtain the target result ciphertext.

Specifically, the fine-tuned model is used for performing privacy inference on the target input ciphertext based on an inference-related parameter by the server to obtain the target result ciphertext.

In S605, the target result ciphertext is sent to the client so that the client performs decryption on the target result ciphertext to obtain a target result plaintext.

In the technical solution provided in the embodiment of the present disclosure, the fine-tuning input ciphertext and the fine-tuning tag ciphertext that are sent by the client are received; the encrypted model is finely tuned by using the fine-tuning input ciphertext and the fine-tuning tag ciphertext to obtain the fine-tuned model; the target input ciphertext sent by the client is received; inference is performed on the target input ciphertext by using the fine-tuned model to obtain the target result ciphertext; the target result ciphertext is sent to the client so that the client performs the decryption on the target result ciphertext to obtain the target result plaintext. In the above technical solution, inference is performed on the ciphertext input from the client based on the fine-tuned model to obtain the result ciphertext, and the result ciphertext is transmitted to the client so that the decryption is performed based on the result ciphertext by the client to obtain the result plaintext, thereby bidirectionally protecting data, that is, protecting both data from the client to the server and data from the server to the client.

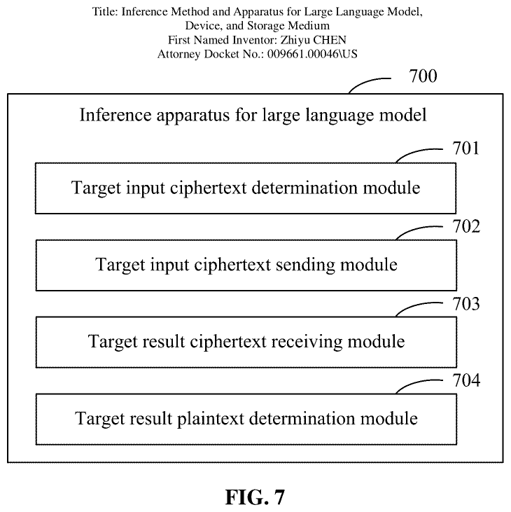

FIG. 7 is a structural diagram of an inference apparatus for large language model according to an embodiment of the present disclosure. This embodiment is applied to the case of how to improve data security in a cloud service, for example, an application scenario like smart question-answering or text retrieval. The apparatus may be implemented by software and/or hardware and may be integrated into an electronic device carrying a large language model inference function, for example, a client. As shown in FIG. 7, the inference apparatus for large language model 700 of this embodiment may include a target input ciphertext determination module 701, a target input ciphertext sending module 702, a target result ciphertext receiving module 703 and a target result plaintext determination module 704.

The target input ciphertext determination module 701 is configured to perform encryption on a target input text to obtain a target input ciphertext.

The target input ciphertext sending module 702 is configured to send the target input ciphertext to a server so that an encrypted model is used for performing inference on the target input ciphertext by the server to obtain a target result ciphertext.

The target result ciphertext receiving module 703 is configured to receive the target result ciphertext sent by the server.

The target result plaintext determination module 704 is configured to perform decryption on the target result ciphertext to obtain a target result plaintext.

In the technical solution provided in the embodiment of the present disclosure, the encryption is performed on the target input text to obtain the target input ciphertext; the target input ciphertext is sent to the server so that the encrypted model is used for performing inference on the target input ciphertext by the server to obtain the target result ciphertext; the target result ciphertext sent by the server is received; the decryption is performed on the target result ciphertext to obtain the target result plaintext. In the above technical solution, inference is performed on the ciphertext input from the client based on the encrypted model to obtain the result ciphertext, and the result ciphertext is transmitted to the client so that the decryption is performed based on the result ciphertext by the client to obtain the result plaintext, thereby bidirectionally protecting data, that is, protecting both data from the client to the server and data from the server to the client.

Further, the target input ciphertext determination module 701 is specifically configured to perform the operations described below.

The target input text is encoded based on a vocabulary of a large language pre-training model to obtain target input encoding.

Transverse jitter encryption is performed on the target input encoding by using a transverse jitter key to obtain the target input ciphertext.

Further, the target result plaintext determination module 704 is specifically configured to perform the operations described below.

The decryption is performed on the target result ciphertext by using a transverse jitter key to obtain a target decryption result.

Text decoding is performed on the target decryption result to obtain the target result plaintext.

Further, the apparatus further includes an encrypted model determination module including a training data determination unit, a transverse jitter data determination unit, a transverse longitudinal jitter layer determination unit and a text and model sending unit.

The training data determination unit is configured to determine jitter key information, a large language pre-training model, a vocabulary of the large language pre-training model and a to-be-jitter training text, where the jitter key information includes a transverse jitter key, the number of rounds of longitudinal jitter and a longitudinal jitter key.

The transverse jitter data determination unit is configured to determine a transverse jitter layer according to the large language pre-training model and the transverse jitter key and determine a transverse jitter training text according to the vocabulary, the transverse jitter key and the to-be-jitter training text.

The transverse longitudinal jitter layer determination unit is configured to perform jitter on the transverse jitter layer according to the number of rounds of longitudinal jitter and the longitudinal jitter key to obtain a transverse longitudinal jitter layer.

The text and model sending unit is configured to send the transverse jitter training text and the transverse longitudinal jitter layer to the server so that the server performs training on a local model based on the transverse jitter training text to obtain the encrypted model.

Further, the transverse jitter data determination unit is specifically configured to perform the operations described below.

A parameter weight of an embedded layer or a presentation layer in the large language pre-training model is acquired.

Transverse jitter is performed on the embedded layer or the presentation layer according to the parameter weight of the embedded layer or the presentation layer and the transverse jitter key to obtain the transverse jitter layer.

Further, the transverse jitter data determination unit is further specifically configured to perform the operations described below.

The to-be-jitter training text is encoded based on the vocabulary to obtain training text encoding.

Transverse jitter processing is performed on the training text encoding by using the transverse jitter key to obtain the transverse jitter training text.

Further, the transverse longitudinal jitter layer determination unit includes a transverse longitudinal jitter layer determination sub-unit.

The transverse longitudinal jitter layer determination sub-unit is configured to perform multiple rounds of jitter on the transverse jitter layer by using the longitudinal jitter key until the number of rounds of jitter reaches the number of rounds of longitudinal jitter to obtain the transverse longitudinal jitter layer.

Further, the transverse longitudinal jitter layer determination sub-unit is specifically configured to perform the operations described below.

A longitudinal jitter key corresponding to an i-th round of jitter is determined for the i-th round of jitter, and longitudinal jitter is performed on an intermediate jitter layer corresponding to an (i-1)-th round of jitter by using the longitudinal jitter key to obtain a transverse longitudinal jitter layer corresponding to the i-th round of jitter, where i is a natural number greater than 0 and is less than or equal to the number of rounds of longitudinal jitter.

When i is 1, the intermediate jitter layer is the transverse jitter layer, and when i is greater than 1, the intermediate jitter layer is a transverse longitudinal jitter layer corresponding to the (i-1)-th round of jitter.

Further, the apparatus further includes a fine-tuned model determination module including a fine-tuning ciphertext data determination unit and a fine-tuning ciphertext data sending unit.

The fine-tuning ciphertext data determination unit is configured to separately perform encryption on a fine-tuning input text and a fine-tuning result tag corresponding to the fine-tuning input text to obtain a fine-tuning input ciphertext and a fine-tuning tag ciphertext.

The fine-tuning ciphertext data sending unit is configured to send the fine-tuning input ciphertext and the fine-tuning tag ciphertext to the server so that the fine-tuning input ciphertext and the fine-tuning tag ciphertext are used for finely tuning the encrypted model by the server to obtain a fine-tuned model.

Further, the fine-tuning ciphertext data determination unit is specifically configured to perform the operations described below.

The fine-tuning input text and the fine-tuning result tag corresponding to the fine-tuning input text are separately encoded based on the vocabulary to obtain fine-tuning input encoding and fine-tuning tag encoding.

Encryption is separately performed on the fine-tuning input encoding and the fine-tuning tag encoding by using the transverse jitter key to obtain the fine-tuning input ciphertext and the fine-tuning tag ciphertext.

Further, the target result plaintext determination module 704 is further configured to perform the operation described below.

The target input ciphertext is sent to the server so that the fine-tuned model is used for performing inference on the target input ciphertext by the server to obtain the target result ciphertext.

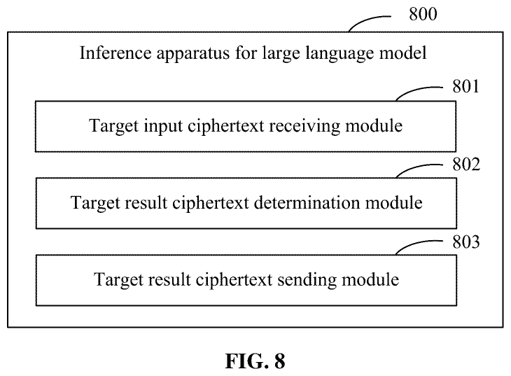

FIG. 8 is a structural diagram of an inference apparatus for a large language model according to an embodiment of the present disclosure. This embodiment is applied to the case of how to improve data security in a cloud service, for example, an application scenario like smart question-answering or text retrieval. The apparatus may be implemented by software and/or hardware and may be integrated into an electronic device carrying a large language model inference function, for example, a server. As shown in FIG. 8, the inference apparatus for large language model 800 of this embodiment may include a target input ciphertext receiving module 801, a target result ciphertext determination module 802 and a target result ciphertext sending module 803.

The target input ciphertext receiving module 801 is configured to receive a target input ciphertext sent by a client.

The target result ciphertext determination module 802 is configured to perform inference on the target input ciphertext by using an encrypted model to obtain a target result ciphertext.

The target result ciphertext sending module 803 is configured to send the target result ciphertext to the client so that the client performs decryption on the target result ciphertext to obtain a target result plaintext.

In the technical solution provided in the embodiment of the present disclosure, the target input ciphertext sent by the client is received; inference is performed on the target input ciphertext by using the encrypted model to obtain the target result ciphertext; the target result ciphertext is sent to the client so that the client performs the decryption on the target result ciphertext to obtain the target result plaintext. In the above technical solution, inference is performed on the ciphertext input from the client based on the encrypted model to obtain the result ciphertext, and the result ciphertext is transmitted to the client so that the decryption is performed based on the result ciphertext by the client to obtain the result plaintext, thereby bidirectionally protecting data, that is, protecting both data from the client to the server and data from the server to the client.

Further, the apparatus further includes an encrypted model determination module configured to perform the operations described below.

A transverse jitter training text and a transverse longitudinal jitter layer that are sent by the client are acquired.

Training is performed on a local model based on the transverse jitter training text to obtain the encrypted model.

Further, the apparatus further includes a fine-tuned model determination module including a fine-tuning ciphertext data receiving unit and a fine-tuned model determination unit.

The fine-tuning ciphertext data receiving unit is configured to receive a fine-tuning input ciphertext and a fine-tuning tag ciphertext that are sent by the client.

The fine-tuned model determination unit is configured to finely tune the encrypted model by using the fine-tuning input ciphertext and the fine-tuning tag ciphertext to obtain a fine-tuned model.

Further, the fine-tuned model determination unit is specifically configured to perform the operations described below.

The fine-tuning input ciphertext is predicted by using the encrypted model to obtain a prediction result ciphertext.

A training loss is determined according to the prediction result ciphertext and the fine-tuning tag ciphertext.

Reverse weight update is performed on the encrypted model by using the training loss to obtain the fine-tuned model.

Further, the target result ciphertext determination module 803 is further configured to perform the operation described below.

Inference is performed on the target input ciphertext by using the fine-tuned model to obtain the target result ciphertext.

According to embodiments of the present disclosure, the present disclosure further provides an electronic device, a readable storage medium and a computer program product.

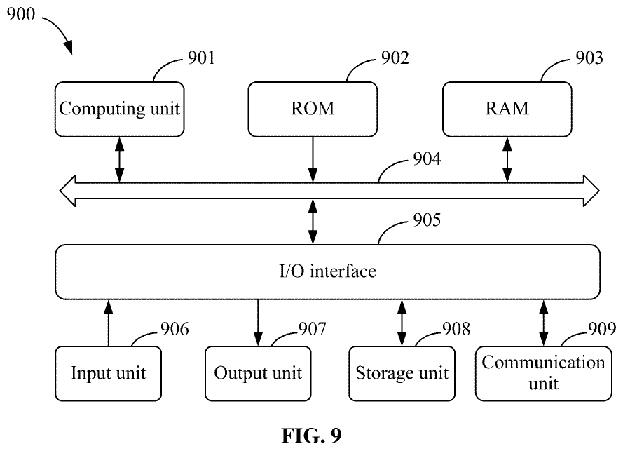

FIG. 9 is a block diagram of an electronic device for implementing an inference method for large language model according to an embodiment of the present disclosure. FIG. 9 is a block diagram illustrative of an exemplary electronic device 900 that may be configured to implement embodiments of the present disclosure. The electronic device is intended to represent various forms of digital computers, for example, a laptop computer, a desktop computer, a worktable, a personal digital assistant, a server, a blade server, a mainframe computer, and an applicable computer. The electronic device may also represent various forms of mobile apparatuses, for example, a personal digital assistant, a cellphone, a smartphone, a wearable device, and a similar computing apparatus. Herein the shown components, the connections and relationships between these components, and the functions of these components are illustrative and are not intended to limit the implementation of the present disclosure as described and/or claimed herein.

As shown in FIG. 9, the electronic device 900 includes a computing unit 901. The computing unit 901 can perform various appropriate actions and processing according to a computer program stored in a read-only memory (ROM) 902 or a computer program loaded into a random-access memory (RAM) 903 from a storage unit 908. Various programs and data required for the operation of the electronic device 900 may also be stored in the RAM 903. The computing unit 901, the ROM 902, and the RAM 903 are connected to each other through a bus 904. An input/output (I/O) interface 905 is also connected to the bus 904.

Multiple components in the electronic device 900 are connected to the I/O interface 905. The multiple components include an input unit 906 such as a keyboard or a mouse, an output unit 907 such as various types of display or speaker, the storage unit 908 such as a magnetic disk or an optical disk, and a communication unit 909 such as a network card, a modem, or a wireless communication transceiver. The communication unit 909 allows the electronic device 900 to exchange information/data with other devices over a computer network such as the Internet and/or various telecommunications networks.

The computing unit 901 may be various general-purpose and/or special-purpose processing components having processing and computing capabilities. Examples of the computing unit 901 include, but are not limited to, a central processing unit (CPU), a graphics processing unit (GPU), a special-purpose artificial intelligence (AI) computing chip, a computing unit executing machine learning models and algorithms, a digital signal processor (DSP), and any appropriate processor, controller and microcontroller. The computing unit 901 performs various methods and processing described above, such as the inference method for large language model. For example, in some embodiments, the inference method for large language model may be implemented as computer software programs tangibly contained in a machine-readable medium such as the storage unit 908. In some embodiments, part or all of computer programs may be loaded and/or installed onto the electronic device 900 via the ROM 902 and/or the communication unit 909. When the computer program is loaded to the RAM 903 and executed by the computing unit 901, one or more steps of the preceding inference method for large language model may be performed. Alternatively, in other embodiments, the computing unit 901 may be configured, in any other suitable manner (for example, by means of firmware), to perform the inference method for large language model.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in a flowchart and/or a block diagram to be implemented when the program codes are executed by the processor or controller. The program codes may be executed entirely on a machine, partly on a machine, as a stand-alone software package, partly on a machine and partly on a remote machine, or entirely on a remote machine or a server.

In the context of the present disclosure, the machine-readable medium may be a tangible medium that may include or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device or any appropriate combination thereof.

In order that interaction with a user is provided, the systems and techniques described herein may be implemented on a computer. The computer has a display device (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of devices may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a user computer having a graphical user interface or a web browser through which a user can interact with embodiments of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), and the Internet.

A computer system may include clients and servers. A client and a server are generally remote from each other and typically interact through a communication network. The relationship between the clients and the servers arises by virtue of computer programs running on respective computers and having a client-server relationship to each other. A server may be a cloud server, a server of a distributed system, or a server combined with a blockchain.

Artificial intelligence is a discipline studying the simulation of certain human thinking processes and intelligent behaviors (such as learning, inference, thinking and planning) by a computer and involves techniques at both hardware and software levels. Hardware techniques of artificial intelligence generally include techniques such as sensors, special-purpose artificial intelligence chips, cloud computing, distributed storage and big data processing. Software techniques of artificial intelligence mainly include several major directions such as computer vision technology, speech recognition technology, natural language processing technology, machine learning/deep learning technology, big data processing technology and knowledge graph technology.

Cloud computing refers to a technical system that accesses a shared elastic-and-scalable physical or virtual resource pool through a network and can deploy and manage resources in an on-demand self-service manner, where the resources may include servers, operating systems, networks, software, applications, storage devices and the like. Cloud computing can provide efficient and powerful data processing capabilities for model training and technical applications such as artificial intelligence and blockchain.

It is to be understood that various forms of the preceding flows may be used with steps reordered, added or removed. For example, the steps described in the present disclosure may be executed in parallel, in sequence, or in a different order as long as the desired results of the technical solutions disclosed in the present disclosure are achieved. The execution sequence of these steps is not limited herein.

The scope of the present disclosure is not limited by the preceding embodiments. It is to be understood by those skilled in the art that various modifications, combinations, sub-combinations and substitutions may be made according to design requirements and other factors. Any modification, equivalent substitution and improvement made within the spirit and principle of the present disclosure is within the scope of the present disclosure.

1. An inference method for a large language model, applied to a client, comprising:
performing encryption on a target input text to obtain a target input ciphertext;
sending the target input ciphertext to a server so that an encrypted model is used for performing inference on the target input ciphertext by the server to obtain a target result ciphertext;
receiving the target result ciphertext sent by the server; and
performing decryption on the target result ciphertext to obtain a target result plaintext.

2. The method according to claim 1, wherein the performing the encryption on the target input text to obtain the target input ciphertext comprises:
encoding the target input text based on a vocabulary of a large language pre-training model to obtain target input encoding; and
performing transverse jitter encryption on the target input encoding by using a transverse jitter key to obtain the target input ciphertext.

3. The method according to claim 1, wherein the performing the decryption on the target result ciphertext to obtain the target result plaintext comprises:
performing the decryption on the target result ciphertext by using a transverse jitter key to obtain a target decryption result; and
performing text decoding on the target decryption result to obtain the target result plaintext.

4. The method according to claim 1, further comprising:
determining jitter key information, a large language pre-training model, a vocabulary of the large language pre-training model and a to-be-jitter training text, wherein the jitter key information comprises a transverse jitter key, a number of rounds of longitudinal jitter and a longitudinal jitter key;
determining a transverse jitter layer according to the large language pre-training model and the transverse jitter key, and determining a transverse jitter training text according to the vocabulary, the transverse jitter key and the to-be-jitter training text;
performing jitter on the transverse jitter layer according to the number of rounds of longitudinal jitter and the longitudinal jitter key to obtain a transverse longitudinal jitter layer; and
sending the transverse jitter training text and the transverse longitudinal jitter layer to the server so that the server performs training on a local model based on the transverse jitter training text to obtain the encrypted model.

5. The method according to claim 4, wherein the determining the transverse jitter layer according to the large language pre-training model and the transverse jitter key comprises:
acquiring a parameter weight of an embedded layer or a presentation layer in the large language pre-training model; and
performing transverse jitter on the embedded layer or the presentation layer according to the parameter weight of the embedded layer or the presentation layer and the transverse jitter key to obtain the transverse jitter layer.

6. The method according to claim 4, wherein the determining the transverse jitter training text according to the vocabulary, the transverse jitter key and the to-be-jitter training text comprises:
encoding the to-be-jitter training text based on the vocabulary to obtain training text encoding; and
performing transverse jitter processing on the training text encoding by using the transverse jitter key to obtain the transverse jitter training text.

7. The method according to claim 4, wherein the performing the jitter on the transverse jitter layer according to the number of rounds of longitudinal jitter and the longitudinal jitter key to obtain the transverse longitudinal jitter layer comprises:
performing a plurality of rounds of jitter on the transverse jitter layer by using the longitudinal jitter key until a number of rounds of jitter reaches the number of rounds of longitudinal jitter to obtain the transverse longitudinal jitter layer.

8. The method according to claim 7, wherein the performing the plurality of rounds of jitter on the transverse jitter layer by using the longitudinal jitter key until the number of rounds of jitter reaches the number of rounds of longitudinal jitter to obtain the transverse longitudinal jitter layer comprises:
determining a longitudinal jitter key corresponding to an i-th round of jitter for the i-th round of jitter, and performing longitudinal jitter on an intermediate jitter layer corresponding to an (i-1)-th round of jitter by using the longitudinal jitter key to obtain a transverse longitudinal jitter layer corresponding to the i-th round of jitter, wherein i is a natural number greater than 0 and is less than or equal to the number of rounds of longitudinal jitter; and
when i is 1, the intermediate jitter layer is the transverse jitter layer, and when i is greater than 1, the intermediate jitter layer is a transverse longitudinal jitter layer corresponding to the (i-1)-th round of jitter.

9. The method according to claim 4, further comprising:
separately performing encryption on a fine-tuning input text and a fine-tuning result tag corresponding to the fine-tuning input text to obtain a fine-tuning input ciphertext and a fine-tuning tag ciphertext; and
sending the fine-tuning input ciphertext and the fine-tuning tag ciphertext to the server so that the fine-tuning input ciphertext and the fine-tuning tag ciphertext are used for finely tuning the encrypted model by the server to obtain a fine-tuned model.

10. The method according to claim 9, wherein the separately performing the encryption on the fine-tuning input text and the fine-tuning result tag corresponding to the fine-tuning input text to obtain the fine-tuning input ciphertext and the fine-tuning tag ciphertext comprises:
separately encoding the fine-tuning input text and the fine-tuning result tag corresponding to the fine-tuning input text based on the vocabulary to obtain fine-tuning input encoding and fine-tuning tag encoding; and
separately performing encryption on the fine-tuning input encoding and the fine-tuning tag encoding by using the transverse jitter key to obtain the fine-tuning input ciphertext and the fine-tuning tag ciphertext.

11. The method according to claim 9, further comprising:
sending the target input ciphertext to the server so that the fine-tuned model is used for performing inference on the target input ciphertext by the server to obtain the target result ciphertext.

12. An inference method for large language model, applied to a server, comprising:
receiving a target input ciphertext sent by a client;
inference the target input ciphertext by using an encrypted model to obtain a target result ciphertext; and
sending the target result ciphertext to the client so that the client performs decryption on the target result ciphertext to obtain a target result plaintext.

13. The method according to claim 12, wherein a process of determining the encrypted model comprises:
acquiring a transverse jitter training text and a transverse longitudinal jitter layer that are sent by the client; and
performing training on a local model based on the transverse jitter training text to obtain the encrypted model.

14. The method according to claim 13, further comprising:
receiving a fine-tuning input ciphertext and a fine-tuning tag ciphertext that are sent by the client; and
finely tuning the encrypted model by using the fine-tuning input ciphertext and the fine-tuning tag ciphertext to obtain a fine-tuned model.

15. The method according to claim 14, wherein the finely tuning the encrypted model by using the fine-tuning input ciphertext and the fine-tuning tag ciphertext to obtain the fine-tuned model comprises:
predicting the fine-tuning input ciphertext by using the encrypted model to obtain a prediction result ciphertext;
determining a training loss according to the prediction result ciphertext and the fine-tuning tag ciphertext; and
performing reverse weight update on the encrypted model by using the training loss to obtain the fine-tuned model.

16. The method according to claim 14, further comprising:
performing inference on the target input ciphertext by using the fine-tuned model to obtain the target result ciphertext.

17-32. (canceled)

33. An electronic device, comprising:
at least one processor; and
a memory communicatively connected to the at least one processor;
wherein the memory stores instructions executable by the at least one processor to cause the at least one processor to perform an inference method for a large language model, wherein the inference method comprises:
performing encryption on a target input text to obtain a target input ciphertext;
sending the target input ciphertext to a server so that an encrypted model is used for performing inference on the target input ciphertext by the server to obtain a target result ciphertext;
receiving the target result ciphertext sent by the server; and
performing decryption on the target result ciphertext to obtain a target result plaintext.

34. A non-transitory computer-readable storage medium storing computer instructions for causing a computer to perform the inference method for the large language model according to claim 1.

35. (canceled)
